(19) United States
(12) Patent Application Publication
(10) Pub. No.: US 2012/0026584 A1
(43) Pub. Date: Feb. 2, 2012

(54) SYSTEM AND DEVICE FOR GENERATING 3D IMAGES

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/944,760

(22) Filed: Nov. 12, 2010

(30) Foreign Application Priority Data
Jul. 29, 2010 (TW) 99125204

(51) Int. Cl. G02B 27/26

(52) U.S. Cl. 359/465

(57) ABSTRACT

A device for generating 3D images includes a reflective display, two light sources, a controller and two laser sheets. The reflective display displays images. The two light sources are oppositely placed in front of the reflective display. The controller directs two light sources to alternately emit light. The two laser sheets are respectively mounted below the two light sources. One of the two laser sheets polarizes the light from one of the two light sources to P-polarized light, and the other laser sheet is for polarizing the light from the other light source to S-polarized light. The reflective display receives the alternate P-polarized light and S-polarized light, and alternately reflects P-polarized images and S-polarized images.

### BACKGROUND

1. Technical Field

The present disclosure relates to a system and a device for generating 3D images.

2. Description of Related Art

Two projectors are often used to project images onto a screen from two different directions to achieve a 3D effect. Different two-dimensional image information is delivered due to the parallax generated by the eyes being separated by about 6.5 mm. Right and left images are transferred to the brain and then combined such that a 3D image is perceived. However, using two projectors consumes considerable resource and space.

### BRIEF DESCRIPTION OF THE DRAWINGS

FIG. 1 is a schematic view of a system for generating 3D images in accordance with a first embodiment.

FIG. 2 is a schematic view of a system for generating 3D images in accordance with a second embodiment.

### DETAILED DESCRIPTION

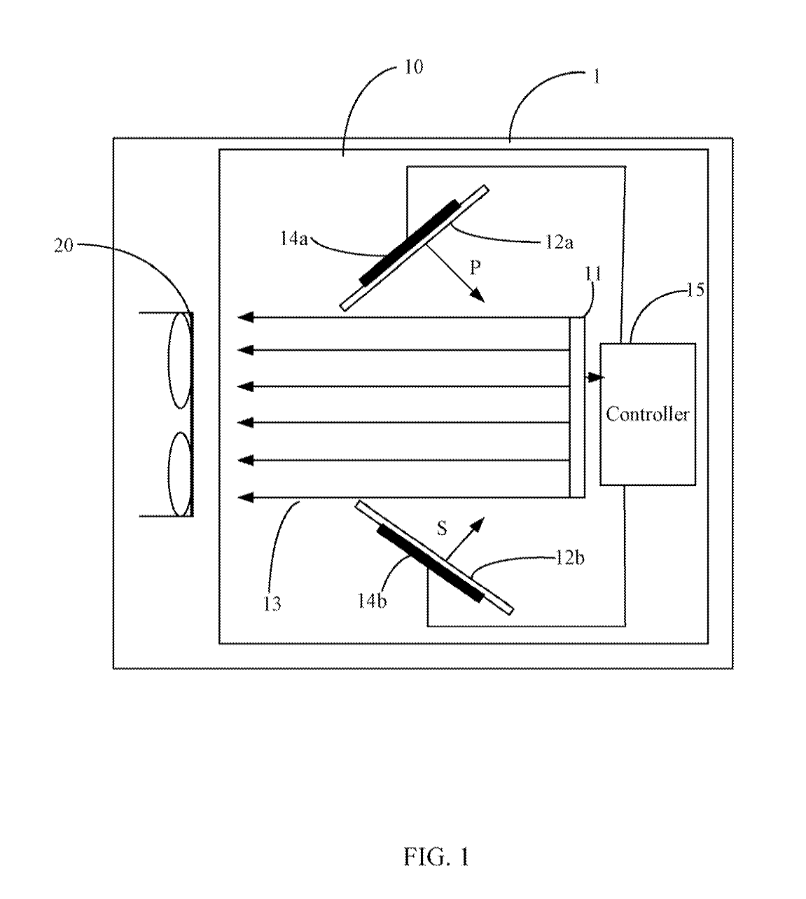

Referring to FIG. 1, a system 1 for generating a 3D image is illustrated. The system 1 includes a device 10 and a pair of stereo glasses 20. The device 10 generates polarized images 13, and the stereo glasses 20 separate the polarized images to both eyes.

The device 10 includes a reflective display 11, two light sources 14a and 14b, a laser sheet 12a mounted below the light source 14a, a laser sheet 12b mounted below the light source 14b, and a controller 15.

The reflective display 11 is for displaying images. In one embodiment, the reflective display 11 may be a liquid crystal on silicon (LCOS), or a micro-electromechanical systems (MEMS) display.

The two light sources 14a and 14b are oppositely placed in front of the reflective display 11. In one embodiment, the two light sources 14a and 14b may be lasers or LEDs.

The controller 15 is for controlling the two light sources 14a and 14b to alternately emit light.

The laser sheet 12a polarizes light from the light source 14a to a P-polarized light, and the laser sheet 12b polarizes light from the light source 14b to an S-polarized light.

The reflective display 11 further receives the alternate P-polarized light and the S-polarized light from the light source 14a and 14b, and alternately reflecting a P-polarized image and a S-polarized image to the stereo glasses 20.

The stereo glasses 20 include a P-polarized filter and a S-polarized filter. The P-polarization filter transmits the P-polarized image through one lens of the glasses. The S-polarized filter transmits the S-polarized image through the other lens of the glasses. Accordingly, a parallax is generated due to the eyes being separated by about 6.5 mm. The S-polarized image and P-polarized image are received and registered. Accordingly, a 3D image is perceived.

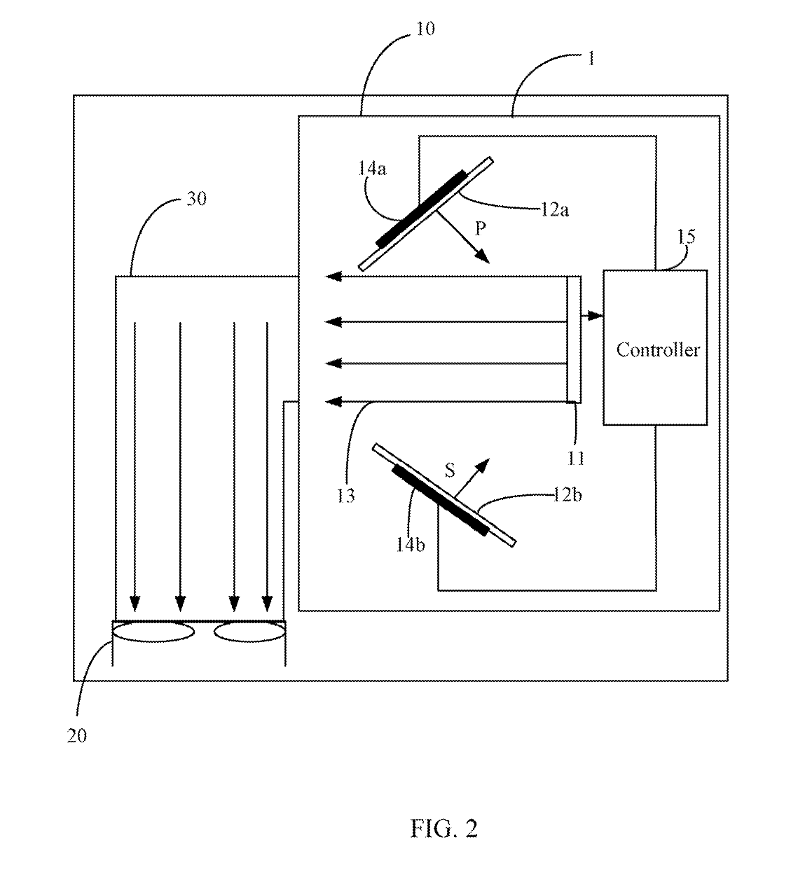

Referring to FIG. 2, the system 1 further includes an optical fiber 30, one end of which is connected to the device 10 and the other end of which is connected to the stereo glasses 20, transmitting the P-polarized images and the S-polarized images to the stereo glasses 20. Alternatively, the optical fiber 30 can reflect the P-polarized images and the S-polarized images to a predetermined direction.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A system for generating 3D images, comprising:
a pair of stereo glasses comprising a P-polarized filter and a S-polarized filter which to respectively transmit P-polarized images and S-polarized images; and
a device comprising:
a reflective display configured for displaying images;
two light sources oppositely placed in front of the reflective display;
a controller configured for controlling two light sources to alternately emit light; and
two laser sheets respectively mounted below the two light sources, wherein one of the two laser sheets is configured for polarizing the light from one of the two light sources to P-polarized light, and the other laser sheet is configured for polarizing the light from the other light source to S-polarized light;
the reflective display further configured for receiving the alternate P-polarized light and S-polarized light, and alternately reflecting P-polarized images and S-polarized images to the stereo glasses.

2. The system for generating 3D images as described in claim 1, wherein the reflective display is a liquid crystal on silicon.

3. The system for generating 3D images as described in claim 1, wherein the reflective display is a micro-electro mechanical systems display.

4. The system for generating 3D images as described in claim 1, further comprising an optical fiber, one end of the optical fiber is connected to the device and the other end is connected to the stereo glasses to transmit the alternate P-polarized images and the S-polarized images to the stereo glasses.

5. The system for generating 3D images as described in claim 4, wherein the optical fiber is further configured for reflecting the P-polarized images and the S-polarized images to a predetermined direction.

6. The system for generating 3D images as described in claim 1, wherein the two light sources are lasers.

7. The system for generating 3D images as described in claim 1, wherein the two light sources are LEDs.

8. A device for generating 3D images, comprising:
a reflective display configured for displaying images;
two light sources oppositely placed in front of the reflective display;
a controller configured for controlling two light sources to alternately emit light; and
two laser sheets respectively mounted below the two light sources, wherein one of the two laser sheets is configured for polarizing the light from one of the two light sources to P-polarized light, and the other laser sheet is configured for polarizing the light from the other light source to S-polarized light;
the reflective display further configured for receiving the alternate P-polarized light and S-polarized light, and alternately reflecting P-polarized images and S-polarized images.

9. The device for generating 3D image as described in claim 8, wherein the reflective display is a liquid crystal on silicon.

10. The device for generating 3D image as described in claim 8, wherein the reflective display is micro-electro mechanical systems display.

11. The device for generating 3D image as described in claim 8, wherein the device is connected to an optical fiber, the optical fiber is configured for reflecting the P-polarized images and the S-polarized images to a predetermined direction.
